(19) United States
(12) Patent Application Publication
(10) Pub. No.: US 2011/0256238 A1
(43) Pub. Date: Oct. 20, 2011

(54) WOOD PRESERVATIVE AND WOOD PROCESSING METHOD

(75) Inventors: Keijitsu Tanaka, Ibaraki (JP); Masahiro Maesawa, Ibaraki (JP)

(73) Assignee: SDS BIOTECH K.K., Chuo-ku, Tokyo (JP)

(21) Appl. No.: 13/142,166

(22) PCT Filed: Dec. 24, 2009
(86) PCT No.: PCT/JP2009/071405

§ 371 Date: Jun. 24, 2011

(30) Foreign Application Priority Data
Dec. 25, 2008 (JP) 2008-330234

(51) Int. Cl. A01N 59/20; A01P 3/00; A01P 1/00; A01N 43/653

(52) U.S. Cl. 424/632; 424/633; 424/634; 424/635; 424/638; 514/383

(57) ABSTRACT

The present invention relates to a wood preservative containing as an active ingredient 3′-isopropyl-2-trifluoromethyl benzoic acid anilide represented by the formula below and a wood treatment method using the same. The present invention can provide a wood preservative having excellent preservation effect on various wood-destroying fungi with a very small chemical dosage and a wood treatment method, which are economical and have a small environmental load.

### TECHNICAL FIELD

The present invention relates to a wood preservative. Specifically, the present invention relates to a wood preservative containing 3′-isopropyl-2-trifluoromethyl benzoic acid anilide having an antiseptic effect, which enables a small environmental load as well as improved economic efficiency owing to its excellent antiseptic effect, and a wood preservative further containing a triazole compound in addition to 3′-isopropyl-2-trifluoromethyl benzoic acid anilide, which enables reducing an environmental load as well as further improving the antiseptic effect and economic efficiency by the synergetic effect.

### BACKGROUND ART

Although the wood is a useful material widely used in various fields, it has a disadvantage of being decayed by wood-destroying fungi and degrading, which causes significant deterioration in the strength. Hence, various inorganic and organic preservative agents have been conventionally used in order to prevent deterioration by various wood-destroying fungi. However, it has been pointed out that such agents have a problem of imposing a huge impact on the human body and a great burden on the environment when they are used in high concentration. Hence, there is a great demand for a more effective preservative agent, which is economical and has a small environmental load.

3′-isopropyl-2-trifluoromethyl benzoic acid anilide (may be hereinafter referred to as “compound A” for short) used as an active ingredient in the present invention belongs to the benzanilide-based preservatives. There are a number of documents relating to the benzanilide-based preservatives since old times. For example JP-B-S53-9739 (Patent Document 1) (U.S. Pat. No. 3,945,823, U.S. Pat. No. 3,947,371) proposes o-trifluoromethyl-m′-isopropoxy benzoic acid anilide to control rice sheath blight, JP-B-S53-12973 (Patent Document 2) (U.S. Pat. No. 4,123,554) proposes 2-methyl benzanilide as a bactericide for agricultural and horticultural use, JP-A-S60-197603 (Patent Document 3) proposes o-trifluoromethyl-m′-isopropoxy benzoic acid anilide as a Serpula lacrymans control agent, JP-B-S48-1171 (Patent Document 4) (GB 1215066) proposes an acid anilide derivative having a specific structure as a composition for a fungicide, JP-A-S52-18819 (Patent Document 5) (U.S. Pat. No. 4,123,554) proposes a 2-iodobenzanilide derivative having a specific structure as a fungicide for agricultural and horticultural use, JP-A-S53-72823 (Patent Document 6) proposes a benzanilide derivative having a specific structure as a fungicide for agricultural and horticultural use, and JP-B-S55-40562 (Patent Document 7) proposes a benzanilide derivative having a specific structure as a wood preservative and antifungal agent. However, no mention of compound A of the present invention has been made in these publications.

JP-B-S55-41202 (Patent Document 8) (GB 1217868) proposes a compound having a structure containing 2-trifluoromethyl benzoic acid (alkylated) anilide as a fungicide for agricultural and horticultural use. However, it has no mention of compound A of the present invention itself and its activity against wood-destroying fungi. As will hereinafter be described, the activity against wood-destroying fungi of the compound disclosed in the document is significantly lower compared to that of compound A.

Although JP-B-S63-38966 (Patent Document 9) proposes a 2-halogenated lower alkylbenz(alkyl)anilide compound as a wood preservative and antifungal agent, it has no mention of compound A of the present invention itself and its activity against wood-destroying fungi. As will hereinafter be described, the activity against wood-destroying fungi of the compound disclosed in the document is significantly lower compared to that of compound A.

Although JP-A-H01-143804 (Patent Document 10) (U.S. Pat. No. 4,942,178) discloses 3′-isopropyl-2-trifluoromethyl benzoic acid anilide as a fungicide for agricultural and horticultural use, it has no mention of the activity against wood-destroying fungi.

### PRIOR ART DOCUMENTS

### Patent Documents

Patent Document 1: JP-B-S53-9739
Patent Document 2: JP-B-S53-12973
Patent Document 3: JP-A-S60-197603
Patent Document 4: JP-B-S48-1171
Patent Document 5: JP-A-S52-18819
Patent Document 6: JP-A-S53-72823
Patent Document 7: JP-B-S55-40562
Patent Document 8: JP-B-S55-41202
Patent Document 9: JP-B-S63-38966
Patent Document 10: JP-A-H01-143804

### DISCLOSURE OF THE INVENTION

### Problems to be Solved by the Invention

An objective of the present invention is to provide a wood preservative and a wood treatment method, which is more effective and economical with a small environmental load.

### Means to Solve the Problem

The present inventors conducted intensive studies extensively regarding effective preservative ingredients against various wood-destroying fungi. As a result, they have found that excellent preservation effect with a very small chemical dosage can be obtained by containing compound A as an active ingredient. Furthermore, they have found that, when compound A and a triazole-based fungicide are contained as active ingredients, synergetic effect between the effects of the two ingredients is seen and excellent preservation effect can be attained with a even smaller chemical dosage. They have accomplished the present invention based on this finding.

That is, the present invention is to provide a wood preservative and a wood treating method as follows.

(1) A wood preservative containing 3′-isopropyl-2-trifluoromethyl benzoic acid anilide represented by the following formula as an active ingredient.

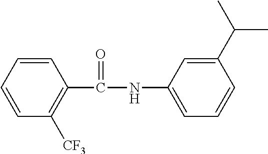

(2) The wood preservative as described in (1) above, which further contains a triazole-based fungicide.
(3) The wood preservative as described in (2) above, wherein the triazole-based fungicide is one or more members selected from cyproconazole, epoxyconazole and tetraconazole.
(4) The wood preservative as described in any one of (1) to (3) above, further containing other antibiotic compounds.
(5) The wood preservative as described in (4) above, wherein the antibiotic compound is selected from copper compounds.
(6) A wood preservative treatment method using the preservative as described in any one of (1) to (5) above.

### Effects of the Invention

The present invention provides a wood preservative using a novel 3′-isopropyl-2-trifluoromethyl benzoic acid anilide which is useful as a wood preservative and a wood treating method.

The wood preservative of the present invention has excellent preservation effect against various wood-destroying fungi with a very small chemical dosage, is economical and has a small environmental load.

### MODE FOR CARRYING OUT THE INVENTION

3′-isopropyl-2-trifluoromethyl benzoic acid anilide (compound A) of the present invention can be produced by known methods and suitably produced by the method described below.

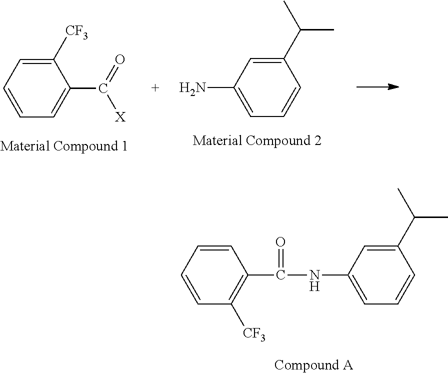

In the above reaction formula, X represents a halogen atom such as chlorine, bromine and iodine, and X is preferably a chlorine atom. The material compound 1 can be obtained by halogenating known 2-trifluoromethyl benzoic acid, which is produced by known methods, using thionyl chloride, oxalyl chloride and the like. As the material compound 2, known 3-isopropyl aniline produced by known methods can be used.

Compound A can be obtained by reacting the material compound 1 and material compound 2 in an inert solvent in the presence of dehydrohalogenation agent according to the above reaction formula.

Examples of the inert solvent include halogenated hydrocarbons such as dichloromethane, chloroform, dichloroethane and carbon tetrachloride; aromatic hydrocarbons such as benzene, toluene and xylene; ethers such as diethyl ether, isopropyl ether, tetrahydrofuran and dioxane; acetone; ethyl acetate; hexane; or a mixed solvent thereof.

As an example of the dehydrohalogenation agent, triethyl amine, diisopropyl ethyl amine, pyridine and the like may be used.

As the reaction temperature, a temperature within the range from 0° C. to the boiling point of the solvent may be selected, and preferably a temperature from room temperature to 150° C. may be selected.

There is no particular limitation on the reaction time and preferably it is about 0.5 to three hours.

The wood preservative of the present invention contains the above-mentioned 3′-isopropyl-2-trifluoromethyl benzoic acid anilide as an active ingredient. In the wood preservative of the present invention, a triazole-based fungicide may further be combined as an active ingredient.

As a triazole-based fungicide used in combination in the present invention, a commercially available product can be used. Examples of the triazole-based fungicide include azaconazole, bitertanol, bromuconazole, cyproconazole, diniconazole, epoxiconazole, fenbuconazole, fluquinconazole, flusilazole, flutriafol, hexaconazole, imibenconazole, ipconazole, metconazole, myclobutanil, paclobutrazol, penconazole, propiconazole, tebuconazole, tetraconazole, triadimefon, triadimenol, triticonazole and uniconazole. Among these, preferred are cyproconazole, epoxiconazole and tetraconazole.

When the wood preservative of the present invention is actually used, the preservative may be used as produced without adding any other ingredients. However, generally, the preservative is applied after being mixed with solid carriers, liquid carriers or gas carriers with addition of a surfactant and other adjuvants for drug formulations as needed to thereby be formulated into the forms such as an oil solution, an emulsion, a solubilizer, a wettable powder, a suspension, a flowable formulation and a dust formulation.

Examples of the solvent which can be used for preparing these formulations include aromatic organic solvents such as toluene-based, xylene-based or methylnaphthalene-based solvents; halogenated hydrocarbon such as dichloromethane and trichloroethane; alcohols such as isopropyl alcohol and benzyl alcohol; glycol-based solvents such as polyethylene glycol and polypropylene glycol; kerosene; N-methylpyrolidone; ester phosphate; and benzoic acid ester.

As the surfactant to be used for formulations, an anionic, nonionic, cationic or zwitterionic surfactant can be used.

These formulations generally contain active ingredients (compound A and/or total amount of compound A and a triazole-based fungicide) in an amount of 0.01 to 90 mass %, and preferably 0.1 to 50 mass %. When compound A and a triazole-based fungicide are used in mixture, the mixing ratio between compound A and the triazole-based fungicide is generally from 1:100 to 100:1, and preferably from 1:10 to 10:1.

When the wood preservative of the present invention is applied to the wood, the preservative concentration is generally from 0.1 to 500 g/m³ (per unit volume of the wood), and preferably from 1 to 100 g/m³ (per unit volume of the wood).

Using the wood preservative of the present invention in combination with other antibiotic compounds enables further enhancing the antibiotic effect and expanding the action spectrum of the drug. The wood treatment using these antibiotic compounds may be carried out as pretreatment or posttreatment of the preservative treatment by the present invention. However, it is effective in saving labor to formulate the antibiotic compound added to the wood preservative of the present invention to thereby carry out the wood treatment at the same time.

Preferable examples of the antibiotic compound which can be used for the above-mentioned purpose include copper compounds. Examples of the copper compound include copper sulfate, copper chloride, copper phosphate, copper hydroxide, copper carbonate, basic copper carbonate, basic copper acetate, basic copper phosphate, basic copper chloride, copper oxide, copper(I) oxide, copper acetate, copper naphthenate, copper oleate, copper stearate, copper octanoate, copper benzoate, copper citrate, copper lactate, copper tartrate, copper 2-ethylhexanoate, complexes of these compounds stabilized as a water-soluble component; and hydrates of these compounds.

When the formulation containing the above-mentioned copper compounds is designed as the wood preservative of the present invention, the blend ratio between the copper compound and compound A is generally 10:1 to 100:1, and preferably from 20:1 to 500:1 by mass. In the case where these formulations are designed to be water-reducible, a copper compound is generally brought into a stable solution and conventionally known ammonium compounds and amine compounds can be used. Specific example of the compounds include ammonia, ammonium carbonate, ammonium bicarbonate, ethanolamine, diethanolamine, triethanolamine, propanolamine, triisopropanolamine, N-methylethanolamine, N-methyl diethanolamine, N,N-dimethylethanolamine, N-ethylethanolamine, N-ethyldiethanolamine, isopropanol amine, aminoethylethanolamine, ethylenediamine, diethylenetriamine, triethylenetetramine, tetraethylenepentamine, pentaethylenehexamine, polyethyleneimine, N,N-dimethylethylenediamine, 1,2-propanediamine, 1,3-propanediamine and polyallylamine. Also, various carbonate compounds, carboxylic compounds or mineral acids may be further added to control the pH. Specifically, boric acid, naphthenic acid, formic acid, acetic acid, propionic acid, hexanoic acid, heptanoic acid, octanoic acid, stearic acid, palmitic acid, oleic acid, benzoic acid, citric acid, lactic acid, tartaric acid, malic acid, succinic acid, adipic acid, fumaric acid, malonic acid, gulconic acid, sebacic acid, cyclohexanoic acid, 2-ethylhexanoic acid, isooctanoic acid, sodium bicarbonate, ammonium bicarbonate, phosphoric acid, sodium dihydrogen phosphate, potassium dihydrogen phosphate and hydrates thereof may be used.

In the wood preservative of the present invention, preferred examples of the other antibiotic compounds to be used in combination for the purpose of enhancing the antibiotic effect and expanding the action spectrum include strobins such as azoxystrobin, picoxystrobin and pyraclostrobin; sulfonamides such as dichlorofluanid (Euparene), tolyfluanid (Methyleuparene), cyclofluanid, folpet and fluorofolpet; benzimidazoles such as carbendazim (MBC), benomyl, fuberitazole, thiabendazole and salts thereof; thiocyanates such as thiocyanatemethylthio benzothiazole (TCMTB), and methylene bis thiocyanate (MBT); quaternary ammonium salts such as benzyl dimethyl tetradecyl ammonium chloride, benzyl-dimethyl-dodecyl ammonium chloride, didecyl-dimethyl ammonium chloride and N-alkyl benzyl methyl ammonium chloride; morpholine derivatives such as C₁₁-C₁₄-4-alkyl-2,6-dimethylmorpholine homologues (Tridemorph) and (±)-cis-4-[3-(t-butylphenyl)-2-methylpropyl]-2,6-dimethylmorpholine (Fenpropimorph, Falimorph); phenols such as o-phenylphenol, tribromophenol, tetrachlorophenol, pentachlorophenol, 3-methyl-4-chlorophenol, dichlorophenol, chlorofen and salts thereof; organic iodine compounds such as 3-iodo-2-propynyl-n-butyl carbamate (IPBC), 3-iodo-2-propynyl-n-hexyl carbamate, 3-iodo-2-propynyl cyclohexyl carbamate, 3-iodo-2-propynyl phenyl carbamate, 3-iodo-2-propynil-n-butyl carbamate, p-chlorophenyl-3-iodo propargylformal (IF-1000), 3-bromo-2,3-diiodo-2-propenylethyl carbonate (Sunplus) and 1-[(diiodomethyl)sulfonyl]-4-methylbenzene (Amical); organic bromo derivatives such as Bronopol; benzisothiazolines such as N-methylisothiazoline-3-on, 5-chloro-N-methylisothiazoline-3-on, 4,5-dichloro-N-octylisothiazoline-3-on and N-octylisothiazoline-3-on (Octylinone); benzisothiazolines such as cyclopentaisothiazoline; pyridines such as 1-hydroxy-2-pyridinethione (or sodium salts, iron salts, manganese salts, zinc salts and the like thereof) and tetrachloro-4-methylsulfonylpyridine; metal soaps such as naphthate, octoate, 2-ethylhexanoate, oleate, phosphate, benzoate and the like of tin, copper and zinc; oxides such as Cu₂O, CuO and ZnO; organic tin derivatives such as tributyltin naphthenate and t-butyltin oxide; metal compounds such as tris-N-(cyclohexyldiazenium dioxine)tributyl tin or potassium salts, and bis-(N-cyclohexyl)diazonium-dioxine copper or aluminum; carbamates such as sodium or zinc salts of dialkyl dithiocarbamate and tetramethylthiuram disulfide (TMTD); nitriles such as 2,4,5,6-tetrachloroisophthalonitrile (Chlorothalonil); antimicrobial agents having an activated halogen atom such as tectamer, bronopol and brumidox; benzothiazoles such as 2-mercaptobenzothiazole and dazomet; quinolines such as 8-hydroxyquinoline; compounds generating formaldehyde such as benzylalcoholmono(poly)hemiformal, oxazolidine, hexahydro-s-triazine and N-methylol-chloroacetamide; boron compounds such as disodium octaborate tetrahydrate, boric acid and borax; fluorine compounds such as sodium fluoride and sodium fluorosilicate; ester phosphates such as azinphos-ethyl, azinphos-methyl, 1-(4-chlorophenyl)-4-(O-ethyl, S-propyl)phosphoryloxypyrazole (TIA-230), chlorpyriphos, tetrachlorvinphos, coumaphos, dethomen-5-methyl, diazinon, dichlorvos, dimethoate, ethoprophos, etholimphos, fenitrothion, pyridafenthion, heptenophos, parathion, parathion-methyl, propetanphos, phosalone, phoxim, pyrimphos-ethyl, pyrimiphos-methyl, profenophos, prothiophos, sulprophos, triazophos and trichlorfon; carbamates such as aldicarb, beniocarb, BPMC (2-(1-methylpropyl)phenylmethyl carbamate), butocarboxym, butoxycarboxym, carbaryl, carbofuran, carbosulfan, chloethocarb, isoprocarb, methomyl, oxamyl, pirimicarb, promecarb, propoxur and thiodicarb; pyrethroids such as allethrin, alphamethrin, empenthrin, profluthrin, tralomethrin, methofluthrin, phenothrin, imiprothrin, cyphenothrin, futarthrin, pyrethrin, prallethrin, furamethrin, dimefluthrin, profluthrin, tefluthrin, bioallethrin, esbiothrin, bioresmethrin, cycloprothrin, cyfluthrin, decamethrin, cyhalothrin, cypermethrin, deltamethrin, permethrin, resmethrin, fenpropathrin, fenfluthrin, fenvalerate, flucythrinate, flumthrin, fluvalinate and ethophenprox; neonicotinoids such as acetamiprid, imidacloprid, thiacloprid, chlothianidin, dinotefuran, thiamethoxam and nitenpyram.

Preferred examples of the antibiotic compound which can be used for the objective of the present invention also include quaternary ammonium compounds represented by the following formula.

[R¹R²N⁺R³R⁴]ₙXⁿ⁻

(In the formula, R¹, R², R³ and R⁴ represent an organic substituent having 20 or less carbon atoms which are joined by a carbon-nitrogen bond, Xⁿ⁻ represents an inorganic or organic anion having a valence of n, and n is 1, 2 or 3.) Specific examples include didecyl dimethyl ammonium chloride, benzalkonium chloride, dioctyl dimethyl ammonium chloride, dilauryl dimethyl ammonium chloride, lauryl trimethyl ammonium chloride, cetyl trimethyl ammonium chloride, octadecyl picolinium chloride, octyldecyl pyridinium ammonium chloride and lauryl isoquinolium bromide.

The wood treatment by these antibiotic compounds may be carried out as pretreatment or posttreatment of the wood treatment by the wood preservative of the present invention. However, as is the case for the above-mentioned copper compounds, it is effective in saving labor to formulate the antibiotic compound added to the wood preservative of the present invention to thereby carry out the wood treatment at the same time. When the formulation containing the above-mentioned antibiotic compounds is designed as the wood preservative of the present invention, the blend ratio between the antibiotic compound and compound A is generally 0.01:1 to 1000:1, and preferably from 0.1:1 to 500:1 by mass.

These antibiotic compounds may be used solely or in combination of the two or more thereof.

[Wood-Destroying Fungi]

The wood preservative of the present invention is effective on the wood-destroying fungi including the following kinds of fungi: basidiomycetes including Coniophora puteana, Trametes versicolor, Postia placenta, Poria vaporaria, Poria vaillantii, Gloeophylium sepiarium, Gloeophylium adoratum, Gloeophylium abietinum, Gloeophylium trabeum, Gloeophylium protactumm, Lentinus lepideus, Lentinus edodes, Lentinus cyathiformes, Lentinus squarrolosus, Paxillus panuoides, Fomitopsis palustris, Pleurotus ostreatus, Donkioporia expansa, Serpula lacrymans, Serpula himantoides, Glenospora graphii, Fomitopsis lilacino-gilva, Perenniporia tephropora, Antrodia xantha and Antrodia vaillantii; Deuteromycetes including Cladosporium herbarum; and Ascomycetes including Chaetomiumu globsum, Chaetomium alba-arenulum, Petriella setifera, Trichurus spiralis and Humicola grisera.

The wood preservative of the present invention is effective on the sap-staining fungi including the following kinds of fungi: Deuteromycetes including Aureobasidium pullulans, Scleroph pithyophila, Scopular phycomyces, Aspergillus niger, Penicillium variabile, Trichoderma viride, Trichoderma rignorum and Dactyleum fusarioides; Ascomycetes including Caratocystis minor; and Zygomycetes including Mucor spinosus.

Treatment Object:

The wood preservative of the present invention is available as the treatment agent of various wood materials, and exerts a positive effects in the treatment of the timber, wood chips, wood meal, plywood, laminated veneer lumber, fiberboard, particle board, manufactured wood products, chaffs, straws, bamboos and the like.

Application as the wood preservative:

The wood preservative of the present invention can be used for the treatment of the lumber, timber, manufactured wood product and wood building. For example, the preservative can be applied to any of the groundsill, sleeper, joist, floor board, furring strip, stud, sheathing floor board, brace, balk, sheathing roof board, bathroom framework and floor framing, exterior materials, log house, balcony, terrace, gate and fence, bower, open verandah, materials for outdoor buildings such as deck materials, railway sleeper, telephone pole, foundation pile, sound abatement shield and civil engineering construction such as bridges. The preservative can be applied to the wood of any form such as logs, boards, square timbers, bars, plywood, laminated veneer lumbers and chipboards.

The treatment using the wood preservative of the present invention can be carried out for the above-mentioned objects in the same way as the usual method carried out as the decay prevention measures. Generally, the application treatment, spraying treatment, dipping treatment, pressure treatment, drilling treatment and the like are performed as the wood treatment; and the treatment on the veneer, treatment by using an adhesive as a chemical mixture, treatment on the plywood laminate and the like are performed as the treatment on the plywood and the laminated veneer lumber. The preservative of the present invention can be applied to any of these treatments.

### EXAMPLES

The invention will be described with reference to Examples below, but the invention is not limited to the description.

### Preparation of the Compound

### Synthesis Example 1

### Compound A

1.3 g of 2-trifluoromethyl benzoic acid chloride (manufactured by Sigma-Aldrich Japan) was dissolved in 20 ml of methylene chloride, and 0.88 ml of triethylamine (manufactured by Wako Pure Chemical Industries, Ltd.) was added thereto in ice bath. After adding 0.85 g of 3-isopropyl aniline (manufactured by Tokyo Chemical Industry Co., Ltd.), the mixture was stirred at room temperature for one hour and refluxed for one hour to cause reaction. After cooling the solution, 20 ml of methylene chloride was added thereto. After washing the solution with 40 ml of 1N NaOH, 40 ml of 1N HCl and 40 ml of saturated saline, the solution was dehydrated with Na₂SO₄ and condensed using an evaporator. The obtained reaction product was purified using silica gel column chromatography, and recrystallized using an ethyl acetate/hexane-based solvent to thereby obtain 1.8 g of pale yellow crystals of 3′-isopropyl-2-trifluoromethyl benzoic acid anilide.

The melting point: 98 to 101° C.,

¹H-NMR (CDCl₃) δ ppm; 7.74-6.68 (8H, m), 3.00-2.77 (1H, m), 1.30 (3H, s), 1.23 (3H, s)

### Synthesis Example 2

### Comparative Compound 1 (Compound Disclosed by JP-A-S53-9739, JP-A-S-60-197603 and JP-B-S63-38966)

The same reaction and posttreatment operation were performed as in Synthesis Example 1 using 1.0 g of 2-trifluoromethyl benzoic acid chloride, 0.70 ml of triethylamine and 0.76 g of 3-isopropoxyaniline (manufactured by Sigma-Aldrich Japan) to thereby obtain 1.5 g of pale yellow crystals of 3′-isopropoxy-2-trifloromethyl benzoic acid anilide.

The melting point: 103 to 106° C.,

¹H-NMR (CDCl₃) δ ppm; 7.88-6.64 (9H, m), 4.69-4.42 (1H, m), 1.37 (3H, s), 1.30 (3H, s)

### Synthesis Example 3

### Comparative Compound 2 (Compound Disclosed by JP-B-S63-38966)

The same reaction and posttreatment operation were performed as in Synthesis Example 1 using 0.77 g of 2-methyl benzoic acid chloride (manufactured by Sigma Aldrich Japan), 0.70 ml of triethylamine and 0.76 g of 3-isopropoxyaniline to thereby obtain 1.3 g of pale yellow crystals of 3′-isopropoxy-2-methyl benzoic acid anilide.

The melting point: 87 to 90° C.,

¹H-NMR (CDCl₃) δ ppm; 7.49-6.62 (9H, m), 4.69-4.43 (1H, m), 2.47 (3H, s), 1.36 (3H, s), 1.30 (3H, s)

### Synthesis Example 4

### Comparative Compound 3 (Compound Disclosed by JP-B-S53-72823 and JP-B-S53-12973)

The same reaction and posttreatment operation were performed as in Synthesis Example 1 using 1.0 g of 2-methyl benzoic acid chloride, 0.88 ml of triethylamine and 0.85 g of 3-isopropylaniline to thereby obtain 1.5 g of pale yellow crystals of 3′-isopropyl-2-methyl benzoic acid anilide.

The melting point: 80 to 83° C.,

¹H-NMR (CDCl₃) δ ppm; 7.53-6.92 (9H, m), 3.07-2.70 (1H, m), 2.51 (3H, s), 1.30 (3H, s), 1.23 (3H, s)

### Synthesis Example 5

### Comparative Compound 4

The same reaction and posttreatment operation were performed as in Synthesis Example 1 using 1.1 g of 2-iodobenzoic acid chloride (manufactured by Sigma Aldrich Japan), 0.56 ml of triethylamine and 0.54 g of 3-isopropopylaniline to thereby obtain 0.8 g of white crystals of 3′-isopropyl-2-iodobenzoic acid anilide.

The melting point: 119 to 122° C.,

¹H-NMR (CDCl₃) δ ppm; 7.95-6.98 (9H, m), 3.08-2.78 (1H, m), 1.30 (3H, s), 1.23 (3H, s)

### Synthesis Example 6

### Comparative Compound 5 (Compound Disclosed by JP-A-S52-18819, JP-A-S53-72823 and JP-B-S63-38966)

The same reaction and posttreatment operation were performed as in Synthesis Example 1 using 1.1 g of 2-iodobenzoic acid chloride, 0.56 ml of triethylamine and 0.60 g of 3-isopropoxyaniline to thereby obtain 0.9 g of pale brown crystals of 3′-isopropoxy-2-iodobenzoic acid anilide.

The melting point: 97 to 100° C.,

¹H-NMR (CDCl₃) δ ppm; 7.90-6.61 (9H, m), 4.69-4.42 (1H, m), 1.36 (3H, s), 1.29 (3H, s)

### Synthesis Example 7

### Comparative Compound 6 (Compound Disclosed by JP-A-H01-143804)

The same reaction and posttreatment operation were performed as in Synthesis Example 1 using 1.2 g of 2-nitrobenzoic acid chloride (manufactured by Sigma-Aldrich Japan), 0.88 ml of triethylamine and 0.85 g of 3-isopropylaniline to thereby obtain 1.5 g of pale yellow crystals of 3′-isopropyl-2-nitrobenzoic acid anilide.

The melting point: 71 to 74° C.,

¹H-NMR (CDCl₃) δ ppm; 7.72-6.91 (9H, m), 3.07-2.77 (1H, m), 1.30 (3H, s), 1.22 (3H, s)

### Synthesis Example 8

### Comparative Compound 7 (Compound Disclosed by JP-A-S63-38966)

The same reaction and posttreatment operation were performed as in Synthesis Example 1 using 1.1 g of 2-bromobenzoic acid chloride (manufactured by Sigma-Aldrich Japan), 0.7 ml of triethylamine and 0.67 g of 3-isopropylaniline to thereby obtain 1.0 g of white crystals of 3′-isopropyl-2-bromobenzoic acid anilide.

The melting point: 86 to 89° C.,

¹H-NMR (CDCl₃) δ ppm; 7.95-6.98 (9H, m), 3.08-2.78 (1H, m), 1.30 (3H, s), 1.23 (3H, s)

### Synthesis Example 9

### Comparative Compound 8 (Compound Disclosed by JP-B-S55-41202)

The same reaction and posttreatment operation were performed as in Synthesis Example 1 using 0.5 g of 2-trifluoromethyl benzoic acid chloride, 0.35 ml of triethylamine and 0.23 g of aniline (manufactured by Sigma-Aldrich Japan) to thereby obtain 0.5 g of colorless crystals of 2-trifloromethyl benzoic acid anilide.

The melting point: 151 to 152° C.,

¹H-NMR (CDCl₃) δ ppm; 7.95-6.98 (10H, m)

### Synthesis Example 10

### Comparative Compound 9

The same reaction and posttreatment operation were performed as in Synthesis Example 1 using 0.5 g of 2-trifluoromethyl benzoic acid chloride, 0.35 ml of triethylamine and 0.27 g of 2-isopropylaniline (manufactured by Sigma-Aldrich Japan) to thereby obtain 0.52 g of colorless crystals of 2′-isopropyl-2-trifloromethyl benzoic acid anilide.

The melting point: 165 to 168° C.,

¹H-NMR (CDCl₃) δ ppm; 7.94-7.17 (9H, m), 3.22-2.92 (1H, m), 1.29 (3H, s), 1.21 (3H, s)

### Synthesis Example 11

### Comparative Compound 10

The same reaction and posttreatment operation were performed as in Synthesis Example 1 using 0.5 g of 2-trifluoromethyl benzoic acid chloride, 0.35 ml of triethylamine and 0.34 g of 4-isopropylaniline (manufactured by Sigma-Aldrich Japan) to thereby obtain 0.37 g of colorless crystals of 4′-isopropyl-2-trifloromethyl benzoic acid anilide.

The melting point: 166 to 168° C.,

¹H-NMR (CDCl₃) δ ppm; 7.90-7.17 (9H, m), 3.06-2.75 (1H, m), 1.29 (3H, s), 1.21 (3H, s)

### Synthesis Example 12

### Comparative Compound 11

The same reaction and posttreatment operation were performed as in Synthesis Example 1 using 0.5 g of 2-trifluoromethyl benzoic acid chloride, 0.35 ml of triethylamine and 0.27 g of m-toluidine (manufactured by Sigma-Aldrich Japan) to thereby obtain 0.7 g of pale yellow crystals of 3′-methyl-2-trifloromethyl benzoic acid anilide.

The melting point: 132 to 135° C.,

¹H-NMR (CDCl₃) δ ppm; 7.63-6.96 (9H, m), 2.37 (3H, m)

### Synthesis Example 13

### Comparative Compound 12

The same reaction and posttreatment operation were performed as in Synthesis Example 1 using 0.5 g of 2-trifluoromethyl benzoic acid chloride, 0.35 ml of triethylamine and 0.30 g of 3-ethylaniline (manufactured by Sigma-Aldrich Japan) to thereby obtain 0.6 g of pale yellow crystals of 3′-ethyl-2-trifloromethyl benzoic acid anilide.

The melting point: 86 to 89° C.,

¹H-NMR (CDCl₃) δ ppm; 7.72-6.97 (9H, m), 2.78-2.53 (1H, q), 1.32-1.16 (3H, t)

### Synthesis Example 14

### Comparative Compound 13

The same reaction and posttreatment operation were performed as in Synthesis Example 1 using 0.5 g of 2-trifluoromethyl benzoic acid chloride, 0.35 ml of triethylamine and 0.40 g of 3-trifluoromethylaniline (manufactured by Sigma-Aldrich Japan) to thereby obtain 0.8 g of pale yellow crystals of 2,3′-trifluoromethyl benzoic acid anilide.

The melting point: 112 to 115° C.,

¹H-NMR (CDCl₃) δ ppm; 7.83-7.25 (m)

### Synthesis Example 15

### Comparative Compound 14

The same reaction and posttreatment operation were performed as in Synthesis Example 1 using 0.5 g of 2-trifluoromethyl benzoic acid chloride, 0.35 ml of triethylamine and 0.44 g of 3-trifluoromethoxyaniline (manufactured by Sigma-Aldrich Japan) to thereby obtain 0.86 g of pale yellow crystals of 3′-trifluoromethoxy-2-trifloromethyl benzoic acid anilide.

The melting point: 67 to 70° C.,

¹H-NMR (CDCl₃) δ ppm; 7.63-7.00 (m)

### Synthesis Example 16

### Comparative Compound 15

The same reaction and posttreatment operation were performed as in Synthesis Example 1 using 0.5 g of 2-trifluoromethyl benzoic acid chloride, 0.35 ml of triethylamine and 0.28 g of 3-fluoroaniline (manufactured by Sigma-Aldrich Japan) to thereby obtain 0.39 g of white crystals of 3′-fluoro-2-trifloromethyl benzoic acid anilide.

The melting point: 119 to 122° C.,

¹H-NMR (CDCl₃) δ ppm; 7.80-6.78 (m)

### Synthesis Example 17

### Comparative Compound 16

The same reaction and posttreatment operation were performed as in Synthesis Example 1 using 0.5 g of 2-trifluoromethyl benzoic acid chloride, 0.35 ml of triethylamine and 0.32 g of 3-chloroaniline (manufactured by Sigma-Aldrich Japan) to thereby obtain 0.59 g of white crystals of 3′-chloro-2-trifloromethyl benzoic acid anilide.

The melting point: 128 to 131° C.,

¹H-NMR (CDCl₃) δ ppm; 7.78-7.09 (m)

### Synthesis Example 18

### Comparative Compound 17

The same reaction and posttreatment operation were performed as in Synthesis Example 1 using 0.5 g of 2-trifluoromethyl benzoic acid chloride, 0.35 ml of triethylamine and 0.43 g of 3-bromoaniline (manufactured by Sigma-Aldrich Japan) to thereby obtain 0.62 g of white crystals of 3′-bromo-2-trifloromethyl benzoic acid anilide.

The melting point: 143 to 146° C.,

¹H-NMR (CDCl₃) δ ppm; 7.84-7.20 (m)

### Synthesis Example 19

### Comparative Compound 18

The same reaction and posttreatment operation were performed as in Synthesis Example 1 using 0.5 g of 2-trifluoromethyl benzoic acid chloride, 0.35 ml of triethylamine and 0.55 g of 3-iodoaniline (manufactured by Sigma-Aldrich Japan) to thereby obtain 0.93 g of white crystals of 3′-iodo-2-trifloromethyl benzoic acid anilide.

The melting point: 150 to 153° C.,

¹H-NMR (CDCl₃) δ ppm; 7.98-6.98 (m)

### Synthesis Example 20

### Comparative Compound 19

The same reaction and posttreatment operation were performed as in Synthesis Example 1 using 0.5 g of 2-trifluoromethyl benzoic acid chloride, 0.35 ml of triethylamine and 0.37 g of 5-isopropyl-2-methyl-aniline (manufactured by Sigma-Aldrich Japan) to thereby obtain 0.78 g of pale yellow crystals of 5′-isopropyl-2′-methyl-2-trifluoromethyl benzoic acid anilide.

The melting point: 129 to 132° C.,

¹H-NMR (CDCl₃) δ ppm; 7.88-6.90 (8H, m), 3.08-2.78 (1H, m), 2.25 (3H, s), 1.30 (3H, s), 1.23 (3H, s)

### Example 1

Each of 1% w/v dimethylsulfoxide solution of compound A and comparative compounds 1 to 19 was prepared. A predetermined amount of the solutions diluted with dimethylsulfoxide were fully mixed in the sterilized potato dextrose agar medium, and 15 ml of the resultant medium was poured into a petri dish 90 mm in diameter and allowed to stand at room temperature. As a control, the potato dextrose agar medium added with dimethylsulfoxide only was also prepared. After the medium was solidified, the mycelia was scooped with the medium from the colony of Coniphora puteana as being a typical wood-decaying fungi, which had been cultivated in advance, using a cork baller 5 mm in diameter; and inoculated in the center of the test medium. The fungi was cultivated in the petri dish at 25° C., and the diameter of the colony spread from the source of inoculum was measured on the seventh day. The growth inhibition ratio between the diameter of the test colony and that of the control was determined by the following formula as an indication of the degree of inhibition. The results are shown in Table 1. Compound A apparently had greater effects on Coniphora puteana compared to the compounds which had been disclosed in the past.

Growth inhibition ratio (%)={(diameter of the control colony−diameter of the test colony)/diameter of the control colony}×100 [Formula 1]

TABLE 1

| | | | Degree of |
|---|---|---|---|
| | | | inhibition on |
| | | | Coniphora |
| Synthesis | | | puteana |
| Example | Compound | Remark | at 0.2 ppm |
| 1 | Compound A | | ∘ |
| 2 | Comparative | Compound disclosed by | ▴ |
| | compound 1 | JP-A-S53-9739, | |
| | | JP-A-S60-197603 & | |
| | | JP-B-S63-38966 | |
| 3 | Comparative | Compound disclosed by | ▴ |
| | compound 2 | JP-B-S63-38966 | |
| 4 | Comparative | Compound disclosed by | ▴ |
| | compound 3 | JP-B-S53-72823 and | |
| | | JP-B-S53-12973 | |
| 5 | Comparative | | ▴ |
| | compound 4 | | |
| 6 | Comparative | Compound disclosed by | ▴ |
| | compound 5 | JP-A-S52-18819, | |
| | | JP-A-S53-72823 & | |
| | | JP-B-S63-38966 | |
| 7 | Comparative | Compound disclosed by | x |
| | compound 6 | JP-A-H01-143804 | |
| 8 | Comparative | Compound disclosed by | ▴ |
| | compound 7 | JP-A-S63-38966 | |
| 9 | Comparative | Compound disclosed by | x |
| | compound 8 | JP-B-S55-41202 | |
| 10 | Comparative | | x |
| | compound 9 | | |
| 11 | Comparative | | x |
| | compound 10 | | |
| 12 | Comparative | | ▴ |
| | compound 11 | | |
| 13 | Comparative | | ▴ |
| | compound 12 | | |
| 14 | Comparative | | x |
| | compound 13 | | |
| 15 | Comparative | | x |
| | compound 14 | | |
| 16 | Comparative | | x |
| | compound 15 | | |
| 17 | Comparative | | x |
| | compound 16 | | |
| 18 | Comparative | | x |
| | compound 17 | | |
| 19 | Comparative | | x |
| | compound 18 | | |
| 20 | Comparative | | x |
| | compound 19 | | |

* Degree of inhibition:
∘: inhibition ratio of 75% or more
Δ: inhibition ratio of 50 to 75%
▴: inhibition ratio of 25 to 50%
x: inhibition ratio of 25% or less

### Example 2

Each of 1% w/v dimethylsulfoxide solution of compound A, cyproconazole (manufactured by Wako Pure Chemical Industries, Ltd.), epoxyconazole (manufactured by Wako Pure Chemical Industries, Ltd.) and tetraconazole (manufactured by Wako Pure Chemical Industries, Ltd.) was prepared. The solutions diluted with dimethylsulfoxide were fully mixed in the sterilized potate dextrose agar medium, and 15 ml of the resultant medium was poured into a petri dish 90 mm in diameter and allowed to stand at room temperature. As a control, the potate dextrose agar medium added with dimethylsulfoxide only was also prepared. After the medium was solidified, the mycelia was scooped with the medium from the colony of Trametes versicolor as being a typical wood-decaying fungi, which had been cultivated in advance, using a cork baller 5 mm in diameter; and inoculated in the center of the test medium. The fungi was cultivated in the petri dish at 25° C., and the diameter of the colony spread from the source of inoculum was measured on the seventh day. The growth inhibition ratio by comparing the diameter of the test colony to that of the control was determined by the above-mentioned formula as an indication of the actual measured growth inhibition ratio. The results are shown in Table 2. The theoretical efficacy ratio of the mixture of the active ingredients (i.e. theoretical growth inhibition ratio) was determined using the following Colby's formula (R. S. Colby, Weeds 15, 20-22 (1967)) to thereby be compared with the actual-measured efficacy ratio (theoretical growth inhibition ratio). The results clearly show that compound A and a triazole-based fungicide have a synergetic effect.

Colby's formula: E=x+y−x·y/100 [Formula 2]

E: theoretical efficacy ratio (theoretical growth inhibition ratio) represented by the ratio (%) to the control when the mixture of active compound B (concentration b) and C (concentration c) was used.
x: efficacy ratio (growth inhibition ratio) represented by the ratio (%) to the control when active compound B was used at a concentration of b.
y: efficacy ratio (growth inhibition ratio) represented by the ratio (%) to the control when active compound C was used at a concentration of c.

TABLE 2

| | | | Actual | |
|---|---|---|---|---|
| | | | measured | Theoretical |
| | | Concen- | growth | growth |
| Fungus | Compounds | tration | inhibition | inhibition |
| under test | under test | (ppm) | ratio (%) | ratio (%) |
| Trametes | Compound A | 0.2 | 35 | — |
| versicolor | cyproconazole | 0.2 | 33 | |
| | Epoxiconazole | 0.2 | 24 | — |
| | Tetraconazole | 0.2 | 25 | — |
| | Compound A + | 0.2 + 0.2 | 100 | 56 |
| | cyproconazole | | | |
| | Compound A + | 0.2 + 0.2 | 100 | 51 |
| | epoxiconazole | | | |
| | Compound A + | 0.2 + 0.2 | 100 | 51 |
| | tetraconazole | | | |

### Example 3

A wood preservative containing 16 mass % of basic copper carbonate, 40 mass % of monoethanol amine and 5 mass % of benzoic acid using distilled water as a solvent. Compound A which had been dissolved in a small amount of ethanol in advance and epoxyconazole were added to the wood preservative until the predetermined concentration is reached.

According to the protocol for the laboratory-scale decay assessment of the wood preservatives (PROTOCOLS FOR ASSESSMENT OF WOOD PRESERVATIVES, LABORATORY DECAY (THE AUSTRALIAN WOOD PRESERVATION COMMITTEE)), the wood preservative was diluted with distilled water until the solution reaches a predetermined concentration and injected under pressure into the test sapwood of radiata pine (20×20×20 mm). The sapwood was air-dried and subjected to the resistance to climate operation according to the protocol. The test specimen provided on the flora of Serpula lacrymans, which had been grown according to the protocol, was left to rot at 20° C. for 12 weeks, and the decrease rate due to the rotting in the mass of the sample specimen before and after testing was measured. The results are indicated by the average values calculated by using nine test specimens per one condition. The results are shown in Table 3. It was proved that a wood preservative having excellent preservation effect with a small chemical dosage can be obtained by using compound A, and by further blending a triazole-based fungicide at the same time, a wood preservative having excellent preservation effect with an extremely small amount dosage can be obtained.

TABLE 3

| | | | | | Decrease |
|---|---|---|---|---|---|
| | | Concentration of active | | | rate in the |
| Fungus | Preserv- | ingredients in wood (*) | | | mass due |
| under | ative | Copper | Compound | Epoxiconazole | to the |
| test | No. | (kg/m³) | A (kg/m³) | (kg/m³) | rotting (%) |
| Serpula | No | 0 | 0 | 0 | 55.6 |
| lacrymans | treatment | | | | |
| | 1 | 1.0 | 0 | 0 | 46.1 |
| | 2 | 1.0 | 0.005 | 0 | 2.8 |
| | 3 | 1.0 | 0.01 | 0 | 1.6 |
| | 6 | 1.0 | 0 | 0.005 | 37.8 |
| | 7 | 1.0 | 0 | 0.01 | 33.5 |
| | 8 | 1.0 | 0.005 | 0.005 | 0.2 |
| | 9 | 1.0 | 0.01 | 0.01 | 0.1 |

(*) Mass of the active ingredients per unit volume of the wood

1. A wood preservative containing 3′-isopropyl-2-trifluoromethyl benzoic acid anilide represented by the following formula as an active ingredient.

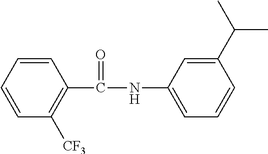

2. The wood preservative as claimed in claim 1, which further contains a triazole-based fungicide.

3. The wood preservative as claimed in claim 2, wherein the triazole-based fungicide is one or more members selected from cyproconazole, epoxyconazole and tetraconazole.

4. The wood preservative as claimed in claim, further containing other antibiotic compounds.

5. The wood preservative as claimed in claim 4, wherein the antibiotic compound is selected from copper compounds.

6. A wood preservative treatment method using the preservative as claimed in claim 1.
